(19) United States
(12) Patent Application Publication
(10) Pub. No.: US 2010/0094797 A1
(43) Pub. Date: Apr. 15, 2010

(54) METHODS AND SYSTEMS FOR PERSONAL INTERACTION FACILITATION

(76) Inventor: Dante Monteverde, Barrington Hills, IL (US)

Correspondence Address: SEYFARTH SHAW LLP, 131 S. DEARBORN ST., SUITE 2400, CHICAGO, IL, 60603-5803, US

(21) Appl. No.: 12/250,421

(22) Filed: Oct. 13, 2008

(51) Int. Cl. G06N 7/04

(52) U.S. Cl. 706/54; 706/46

(57) ABSTRACT

Systems and methods are disclosed for matching users based on a predetermined location, wherein the users receive a link and information thereof based on the predetermined location and on at least one other criterium. In this manner, people seeking personal connections or personal interaction with others can identify those interested in the same, the identification at least in part based on both users being in the same predetermined environment during a predetermined time period. The system and methods utilize input criteria, which may include the users actively providing a location or environment in which they are or will be located, or can utilize location devices carried by the users to determine the users' locations or environments. For instance, a handheld wireless device indicates the user's environment, and other criteria are used to match the user to a second user in the same environment.

### FIELD OF THE INVENTION

The invention relates to identifying and connecting people with like or related interests and, in particular, to systems and methods for facilitating personal connections and interactions between different people based on predetermined or dynamically selected criteria.

### BACKGROUND

Currently, the Internet has vastly improved the ability for people to connect with other people, where the various people were previously unknown to each other. For instance, as Internet Service Providers (ISPs) first arose for providing Internet connection services, many of the ISPs hosted chat groups that were targeted towards specific interest groups, such as knitting, or stamp collecting, or card-playing, or generalized socializing, as examples.

Many people also use the Internet to meet people to create friendships or romantic connections. For instance, services like Facebook and MySpace allow people to link up or connect friends from all over the world, and facilitate meeting new people that are “added” to a user's Facebook or MySpace page. Dating services exists, many of which are targeted towards specific personal characteristics, such as age or religious affiliation.

Similar services also exist for what would be viewed as more professional pursuits. That is, while a user's Facebook or MySpace page would be directed towards the user's favorite foods and music and the user's social friends, a user may separately have a LinkedIn profile or page in which the user's current and past employers are listed, and perhaps their educational background, serving somewhat as a skeleton of a resume. However, a LinkedIn profile allows one to ‘link’ with other professionals, in the same way Facebook and MySpace do, as a networking tool.

While each of the above-described systems has particular advantages, they also generally have a number of disadvantages. First of all, these services generally require using a personal computer or the like to connect with the Internet, and then to log in to a website, and then further to cull through the resources of the website without much structure. These services are wonderful when the user has no predetermined criteria in mind; however, if a user wants to identify someone for a particular purpose, there is virtually no manner in which to narrow the population in a logical manner. As an example, if someone were traveling from Chicago, Ill., to Los Angeles, Calif., and wanted to identify another person for one of any of a variety of reasons, there is no way to do so.

To be more specific, the traveler may be seeking to identify someone in Los Angeles for any of a variety of reasons. As examples, the traveler may seek someone that would be interested in sharing a cup of coffee and discussing living in Los Angeles, or may seek someone that is attending a particular business convention, or may seek someone that is traveling from Los Angeles International Airport to Santa Monica via hired vehicle on a particular day. Furthermore, the traveler may simply have a layover in Los Angeles and may be seeking someone who would be at the airport for a period of time and would be interested in meeting for either social or business purposes. No current Internet service or website currently supports a use in this manner, other than allowing a user to contact other users one-by-one or to broadcast their desires (such as by posting on their own page what is being sought) and hope that an appropriate person randomly finds their broadcast.

Understandably, one of the obvious issues with current Internet services and websites is privacy and security. For instance, a user interested in meeting other people would understandably be concerned about a service that allows unknown people to target where they live, under the pretence of the unknown people being interested in getting to know the user. One can imagine the discomfort that would be felt by a user who posted on a website that they were looking for someone with whom to socialize, only to have someone arrive at the door to their home a short time later.

People are more comfortable about identifying themselves and their desire to meet other people when such may be done without revealing a significant amount of personal information. For instance, people are more than willing to talk with others in coffeehouses, business networking functions, airport lounges, and bars; however, people also typically avoid anyone who is aggressive in asking for certain information, such as one's place of employment or home address. In such environments, some of the people may only be interested in meeting certain other people or may have no desire to meet others. Accordingly, one cannot assume that by another person's mere presence in a cafe or a networking function that approaching them would be received well.

Accordingly, there has been a need for improved methods and systems and devices allowing people to identify other people for personal interaction.

### SUMMARY

In accordance with an aspect, a system for facilitating personal interaction between users at a predetermined environment is disclosed, the system including a set of input criteria for each of a plurality of users, the input criteria corresponding to a desired connection between the respective user and another user, a processor for correlating the criteria, and a link provided by the system to first and second of the users based on the correlated criteria, wherein the link includes information for the first and second users to meet in the predetermined environment.

In some forms, at least one of the first and second users provides input criteria including a present environment in which that user is present, and the predetermined environment of the link is the same as the present environment.

In some forms, at least one of the first and second users provides input criteria including a future environment in which that user will be present, and a time period during which that user will be present in said future environment, and the predetermined environment of the link is the same as the future environment.

In some forms, the processor correlates the criteria based on an input environment for each of the users, wherein the input environment for each of the users is the same.

In some forms, the system includes a search function, where the first of the users may identify the second of the users based upon the predetermined environment being the same. The first user may identify the second user further based upon at least one other criterium.

In some forms, the system includes a sub-system including the processor and including a database of accounts for each user, the sub-system receiving the input criteria from each user and storing the input criteria in the respective accounts, an input component for inputting the input criteria to the sub-system, and a display component for communicating the users the link information. The input component and the display component may both be parts of a single user-carried device. The user-carried device may be a wirelessly-operated device. Alternative, the input component and display components may be separate devices.

In some forms, the system further includes a location component for each user for inputting a present environment of each user. The input component and the location component may both be parts of a single user-carried device. The location component for each user may provide a location within a present environment of each user, and the link information may include said location.

In some forms, the sub-system matches users in the predetermined environment based upon the users being present in said environment during a predetermined time period, and wherein the sub-system communicates the link information to for the users to personally identify each other.

In another aspect, a method of facilitating personal interaction between users is disclosed, the method including the steps of providing users with an input component, receiving input criteria regarding desired matches for interaction, the input criteria including at least one predetermined environment, correlating the input criteria for a plurality of users, and providing a link between at least two matched users, the two matched users having a like predetermined environment and at least one other matched criterium.

In some forms, the step of providing users with an input component includes each user possessing a wirelessly-operating device.

In some forms, the input criteria of the predetermined environment is established by the user's presence in the predetermined environment. The user's presence may be established by one of the user logging into a system in the environment, or the user possessing a location device communicating the user's presence in the environment.

In some forms, the step of providing the link includes displaying information to each of the users for personal identification of each other. The step of displaying information may include displaying the information on a user-carried device.

### BRIEF DESCRIPTION OF THE DRAWINGS

FIG. 1 is a graphical representation of an environment for in which a system of the present invention operates, the environment being depicted as an airport having a plurality of terminals and a plurality of users located thereat;

FIG. 2 is a graphical representation of a system of the present invention including a central sub-system for receiving input criteria from users to correlate the input data to provide a link between at least two users;

FIG. 3 is a graphical representation of forms of the system including users optionally utilizing location devices for providing an input location, and/or other devices for communicating input criteria to the system, and/or other devices for receiving link information from the system;

FIGS. 4A-4D illustrate various forms of components for displaying link information to a user in the form of a map with identifying information such as a location dot;

FIGS. 5A and 5B respectively illustrate a first subset of link information in the form of initial link information and a second subset of link information in the form of subsequent link information;

FIG. 6 illustrates input criteria including active input criteria and inactive input criteria; and

FIG. 7 illustrates the system being operated by a service provide, the system including a plurality of subscriptions for accounts, the accounts including login information.

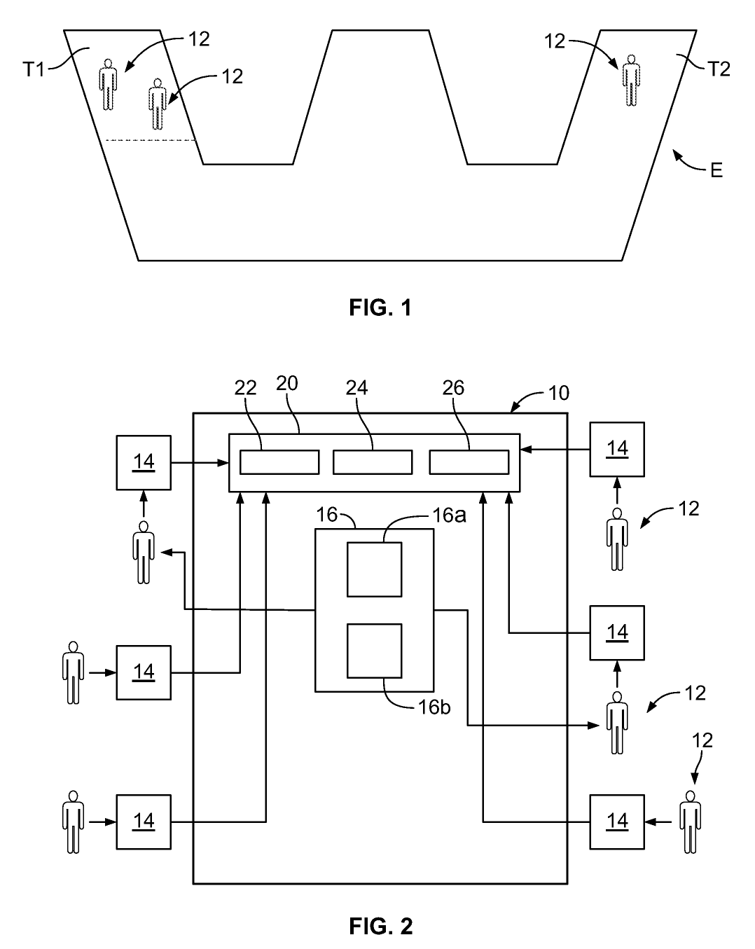

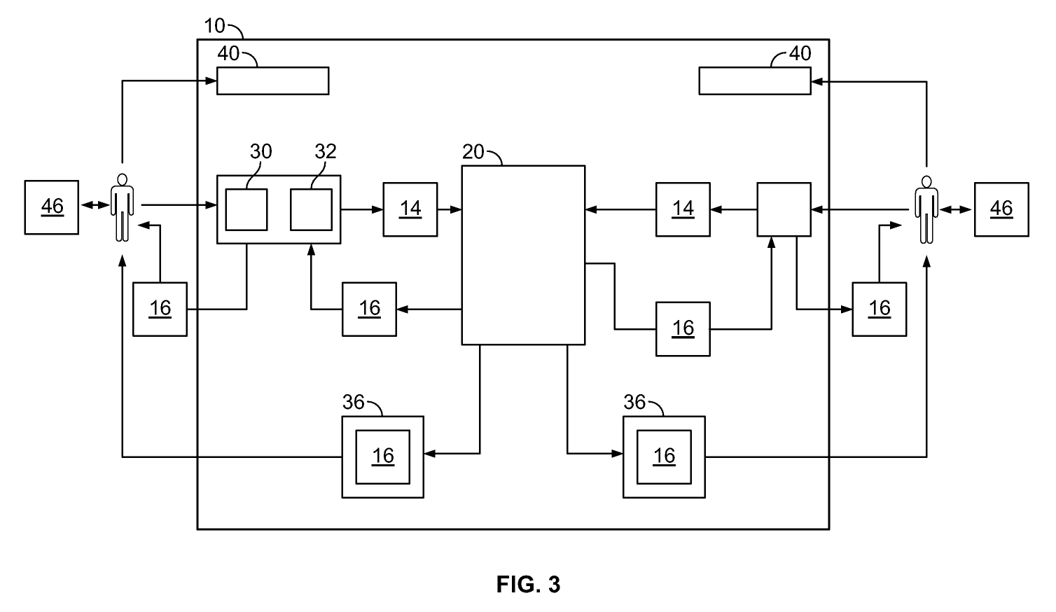

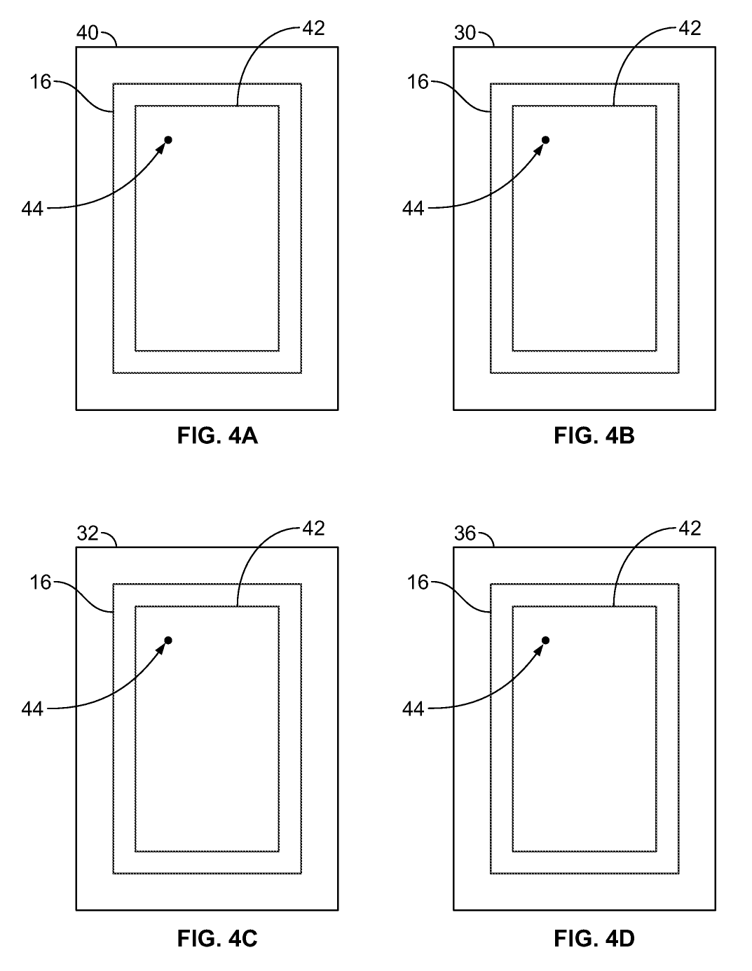

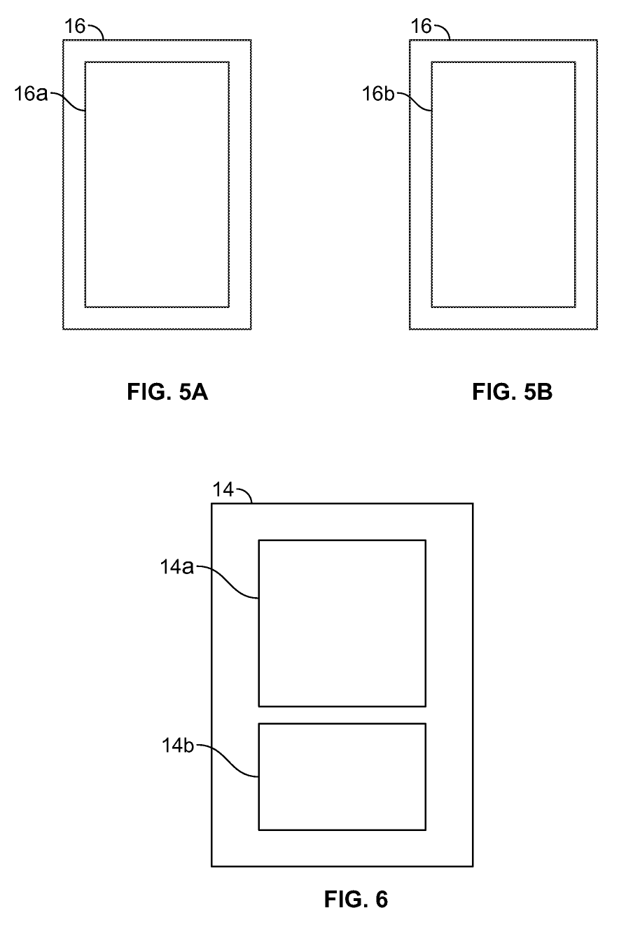

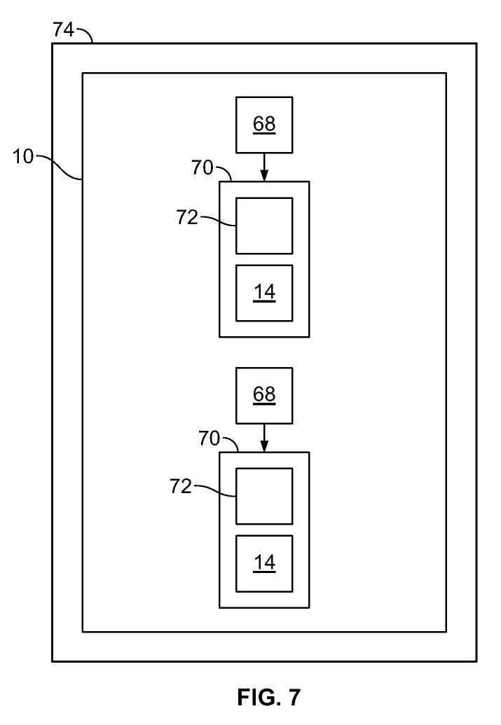

### DETAILED DESCRIPTION

Referring to the Figs., a representational environment 17E is depicted that supports a system 10 of the present invention for facilitating personal interaction between users 12. In a form of the system 10, users 12 provide predetermined information or criteria 14 which is matched or linked with similar or relevant criteria 14 for the other users 12 on a dynamic or real time basis. Based on the linking, the users 12 are then identified to each other so that personal interaction can occur based on the linking.

In a first exemplary form utilized for ease of understanding the context of the system 10, the environment E is an airport. A typical major airport while have thousands of travelers on any given day. A user 12 located in the airport E has virtually no practical manner for identifying any subset of the other travelers. The user 12 may have a variety of criteria 14 that may be of interest, including as mere examples: someone to have a meal with during a layover, someone to network with simply for the sake of networking, someone who will be using a hired vehicle to reach another destination (such as a hotel or convention center) and would be willing to share a ride, or someone who is vacationing at the same spot and might be willing to pal-around. Another example may be a first user 12 who is on their way to a business meeting with a particular company or organization, and the first user 12 hopes to identify a second user 12 who is leaving a similar meeting so that the first user 12 can get some insight into the company; for example, a rather large percentage of people traveling to and from certain cities are doing so because of a larger company based in that city, such as Wal-Mart being based in Bentonville, Ark.

Continuing with the airport as the environment E, a user 12 utilizes the system 10 to indicate the desired criterium or criteria 14. The system 10 then operates to link the user 12 with other users 12 having same or like criteria 14. In other words, a link 16 is created between and provided to the users 12.

The system 10 may include a number of different components. In one form, each user 12 may input data in the form of criteria 14 to a remote sub-system 20 including a central database 22, a processor 24 for matching criteria 14 of different users 12, and communications connections 26 for communicating with a plurality of users 12. In some forms, the users 12 may input the criteria 14 via personal computers 30 utilizing a login through the Internet, and/or input the criteria 14 via handheld devices 32 such as smartphones or personal data assistants (PDAs). In some forms, the users' 12 personal computers 30 or handheld devices 32 may provide the user 12 with the link 16 to the other user(s) 12, while in other forms the environment E may include display monitors 36.

Therefore, a user 12 may input criteria 14 either before or upon reaching the environment E. In the latter case, the environment E may include, as part of the system 10, a resident input device 40 such as a personal computer. The user 12 may then receive on their personal computer 30 or handheld device 32 the link 16 information so that the other user 12 is identified, or the link 16 information may be displayed on a monitor 36. The link 16 information may include a location 44 by showing the user 12 a map 42 of the environment E (such as a representation of an airport lounge) with an indicator (such as a dot) where the other user 12 is. The locations 44 of each user 12 are determined by a location device 46 which, by way of example, may be a GPS device or radio frequency identification tag (RFID tag). The users 12 may provide their own GPS devices, such as a handheld device in the form of a cellular or smartphone or a PDA, or may be provided with the location device 46 when they arrive or enter the environment E. In other forms, the link 16 information may include a description of the user 12 (such as a distinctive item of clothing) or a graphical representation such as a photo.

After the users 12 have provided the criteria 12, and are present in the environment E, the link 16 information is provided or established. In some environments E, the link 16 may be tiered; that is, upon arrival at an airport, the users 12 that are linked may not be in close proximity, or one user 12 may ask the other user 12 if there is sufficient interest to meet. Therefore, the system 10 may provide an initial amount of information 16a, such as a message from one user 12 to the other user 12 or such indicating that one user 12 is in one airport terminal T1 while the other is in another terminal T2, possibly suggesting that the two users 12 meet at a particular location. After the initial link information 16a is acted upon, subsequent link information 16b may be provided; for instance, once the two users 12 are recognized as being in proximity or being receptive to meeting (such as by location devices, or by acknowledgement to the system 10), subsequent information 16b can be given, such as a photo or physical description or a pinpoint location.

It should be recognized that, as noted above, the criteria 12 may be provided beforehand. Therefore, in some forms, a user 12 may input that he/she plans on being in an environment E for a particular period of time, and that he/she would be interested in meeting with someone during that time. Another user 12 may similarly input such criteria 12, and the two may be provided a link 16 well before ever arriving at the environment E. The link 16 may include all the information necessary for one user 12 to locate the other user 12, or may simply be the initial information 16a while the subsequent information 16b can be given upon arrival at the environment E. Additionally, the initial information 16a can serve for the users 12 to establish direct contact so that they may acquaint themselves somewhat prior to meeting in person, or to inform the other of changes to their plans (such as delayed flights, or simply abandonment of the plans altogether).

The system 10 can be used in a variety of contexts. The system 10 can be entirely supported by current cellular communications networks so that the environment E can be anywhere that cellular signals are available. Thus, the environment E may be a coffeehouse, a bar, a social club, a restaurant, an airport, a bus or train terminal, a convention center, a vacation destination, a hotel, a beach or a public park, an athletic event such as a stadium or a public race, etc. Accordingly, users 12 may rely simply upon their personal computer 30 or handheld device 32 to communicate with the system 10 (both for input of criteria 14 and for receiving the link 16). In this manner, it is simple for a user 12 at a coffeehouse environment E, for instance, to indicate that they are seeking a romantic date, and another user 12 can be linked (thus creating the link 16) that is also seeking a romantic date. The two users 12 are identified to each other (via the link 16) so that they can then interact on a personal level (though they may begin their interactions via their computer 30 or handheld device 32). Thus, the users 12 need not be worried about providing a significant amount of information (such as a phone number or home address) prior to meeting. Additionally, in each of the examples discussed herein, the system 10 allows users 12 to avoid wasting time with the hit-or-miss nature of talking to everyone that comes along, and/or trying to guess at whom may be interested in talking, regardless of the purpose being business or social. Preferably, the system 10 allows the users 12 to utilize, at their option, exclusively wirelessly-operated devices such as cellular device that may or may not be Internet capable.

The environment E may specifically seek to host and target users 12 as a paid-for service, and may provide equipment therefor. As described, the environment E may provide a local system 10 including the resident input device 40. The system 10 matches the input criteria 14 for the users 12 and provides the links 16 therebetween. In the simplest form, the system 10 provides the link 16 via the monitors 36. Again, the link 16 may be provided in a number of forms including user pictures, the users' first names and last initials, or identifying descriptions. In more developed forms, each user 12 utilizes a device (such as the location device 46, discussed above, which can be simple like an RFID or can be capable of two-way communication such as a cellular device). In the case of the RFID, a user 12 would rely on either monitors 36 or handheld devices to locate the other user 12. In the case of a cellular device, the link 16 information may be privately provided. Additionally, the supplied device 60 in the form of a two-way communication device may be utilized to input the criteria 14.

The input criteria 14 can be of many different types. Each user 12 may have an active set 14a of criteria 14 and an inactive set 14b of criteria 14. In this manner, the user 12 can activate the active set 14a for a limited use (say, a few hours at an airport) for which such limited use is applicable. Settings on the input criteria 14 can indicated whether the active set 14a is to expire and automatically be deleted, or should simply revert to being stored and inactive criteria 14 for later use. Thus, a user 12 may utilize the system 10 at one point for meeting people for social purposes (say, a person of a particular religion desiring only to meet people of the same faith at a coffeehouse), and may utilize the system 10 at another time for meeting people for other purposes (say, a person interested in sharing a ride from an airport to a convention center).

As noted, the criteria 14 may relate to any purpose whatsoever, including business and social purposes. Examples of criteria include number of years of education, religion, sports of interest or favorite sports teams, music including favorite genres or groups, age, hometown, current address or neighborhood (either business or home), profession or job function, personal description (which can be matched in the same way search engines might) or descriptive terms, pets, personal interests such as movies and arts and theater or other hobbies, languages spoken, special interests, memberships or social and political affiliations, employer, destination, marital or relationship status, etc.

In some forms, the system 10 requires a subscription 68. Therefore, each user 12 is provided with an account 70 having a login 72 and storing the criteria 14. A service provider 74 hosts the subscription 68 and system 10. The service provider 74 may provide background screening such as by requiring a valid credit card matching an address provided, by validating phone numbers and addresses, by checking references for professional purposes, and/or by running criminal background checks, as examples. Such background check information would preferably not be divulged unless required by operation of law or order of a court. It should be noted that the subscription 68 may require a fee or may be provided for free in order for the service provider 74 to transmit advertisements to the users 12.

In some forms, the users 12 may utilize the input criteria 14 of others to identify their own matches, thus creating the link 16. That is, a user 12 may use their personal computer 30 or handheld device 32 to identify other users 12 that are either in proximity or have indicated they will be at a particular location at a particular time (i.e., a coffeehouse an airport lounge), and the users 12 may then review whatever criteria 14 that have been selected as the active criteria 14a for that user 12. The users 12 can then provide an indication of interest to the other users 12 via the system 10 in an attempt to see if a link 16 is desirable, and the system 10 can support interaction, via the system 10, between the users 12, as well as provide the link 16 that allows the users 12 to identify each other in person and actually meet face-to-face, if desired. Thus, the users 12 are allowed to change their criteria 14 (both in terms of their own active criteria 14a and the search criteria 14 for identifying the other user 12) in a dynamic manner, and the link 16 can be dynamically created based on matching or correlating the criteria 14 between users 12.

It should be understood that, as used herein, the term environment E is intended to be broad while provided for sub-environments or locations. That is, the term environment E may encompass a park or an airport, and may further be defined by a particular portion of a park or an area (airport lounge or restaurant) in an airport. Thus, generally speaking, the system 10 matches the users 12 and provides a link 16 based on the environment being same; however, the environment E being the same need only entail both users 12 being at the airport or the park, and while the link 16 information may be broad enough to describe simply the airport or may be specific enough to describe a particular restaurant, lounge, or gate within the airport.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A system for facilitating personal interaction between users at a predetermined environment, the system comprising:
a set of input criteria for each of a plurality of users, the input criteria corresponding to a desired connection between the respective user and another user;
a processor for correlating the criteria; and
a link provided by the system to first and second of the users based on the correlated criteria, wherein the link includes information for the first and second users to meet in the predetermined environment.

2. The system of claim 1 wherein at least one of the first and second users provides input criteria including a present environment in which that user is present, and the predetermined environment of the link is the same as the present environment.

3. The system of claim 1 wherein at least one of the first and second users provides input criteria including a future environment in which that user will be present, and a time period during which that user will be present in said future environment, and the predetermined environment of the link is the same as the future environment.

4. The system of claim 1 wherein the processor correlates the criteria based on an input environment for each of the users, wherein the input environment for each of the users is the same.

5. The system of claim 1 including a search function, where the first of the users may identify the second of the users based upon the predetermined environment being the same.

6. The system of claim 5 wherein the first user identifies the second user further based upon at least one other criterium.

7. The system of claim 1 including:
a sub-system including the processor and including a database of accounts for each user, the sub-system receiving the input criteria from each user and storing the input criteria in the respective accounts;
an input component for inputting the input criteria to the sub-system; and
a display component for communicating the users the link information.

8. The system of claim 7 wherein the input component and the display component are both part of a single user-carried device.

9. The system of claim 8 wherein the user-carried device is a wirelessly-operated device.

10. The system of claim 7 wherein the input component and display components are separate devices.

11. The system of claim 10 further including a location component for each user for inputting a present environment of each user.

12. The system of claim 11 wherein the input component and the location component are both part of a single user-carried device.

13. The system of claim 11 wherein the location component for each user provides a location within a present environment of each user, and the link information includes said location.

14. The system of claim 7 wherein the sub-system matches users in the predetermined environment based upon the users being present in said environment during a predetermined time period, and wherein the sub-system communicates the link information to for the users to personally identify each other.

15. A method of facilitating personal interaction between users, the method including the steps of:
providing users with an input component;
receiving input criteria regarding desired matches for interaction, the input criteria including at least one predetermined environment;
correlating the input criteria for a plurality of users; and
providing a link between at least two matched users, the two matched users having a like predetermined environment and at least one other matched criterium.

16. The method of claim 15 wherein the step of providing users with an input component includes each user possessing a wirelessly-operating device.

17. The method of claim 15 wherein the input criteria of the predetermined environment is established by the user's presence in the predetermined environment.

18. The method of claim 17 wherein the user's presence is established by one of the user logging into a system in the environment, or the user possessing a location device communicating the user's presence in the environment.

19. The method of claim 15 wherein the step of providing the link includes displaying information to each of the users for personal identification of each other.

20. The method of claim 19 wherein displaying information includes displaying the information on a user-carried device.
